(19) United States
(12) Patent Application Publication
(10) Pub. No.: US 2003/0065727 A1
(43) Pub. Date: Apr. 3, 2003

(54) Systems and methods for providing secured electronic messaging

(75) Inventors: Forrest James Clarke, Richmond, VA (US); Bradley Carl Zeigler, Richmond, VA (US); Abhik Sengupta, Richmond, VA (US)

Correspondence Address: Finnegan, Henderson, Farabow, Garrett & Dunner, L.L.P., 1300 I Street, N.W., Washington, DC, 20005-3315, US

(73) Assignee: Capital One Financial Corporation

(21) Appl. No.: 10/138,566

(22) Filed: May 6, 2002

Related U.S. Application Data
(60) Provisional application No. 60/325,216, filed on Sep. 28, 2001.

(51) Int. Cl. G06F 15/16

(52) U.S. Cl. 709/206; 709/246

(57) ABSTRACT

Systems and methods are disclosed for providing secured messaging in a communications network environment. The network environment may include public communication channels or networks, such as the Internet. Embodiments of the invention may be implemented to facilitate secured electronic messaging between any combination of entities, such as one or more customer locations and a message center. Further, consistent with embodiments of the invention, arrangements may be provided to permit the servicing of customers within a network environment that integrates legacy systems associated with a message center.

### CROSS-REFERENCE TO RELATED APPLICATIONS

This application claims the benefit of priority under 35 U.S.C. §119(e) to U.S. Provisional Application No. 60/325,216, filed on Sep. 28, 2001, the entire contents of which are incorporated by reference herein.

### BACKGROUND OF THE INVENTION

I. Field of the Invention

The present invention relates to the fields of communications and electronic messaging. More particularly, the invention relates to systems and methods for providing secured electronic messaging in a communications network environment.

II. Background Information

To retain customers and improve sales, many businesses provide customer contact or message centers. Such message centers are staffed with customer agents or representatives to answer questions and provide assistance to customers. A customer message center may be implemented as a call center to permit customers to interact with representatives by telephone. In such cases, a toll-free number may be provided to access the call center by telephone and gather needed information (such as product or account information). Message centers may also permit customers to submit inquiries by written correspondence or mail. In certain cases, businesses may provide help desks or kiosks that are located at store location(s) or in shopping area(s) to directly service customers.

In today's technology-driven world, many customers expect fast and convenient assistance of their service needs from businesses. As a result, instead of using more traditional forms of communication (such as written correspondence or in-person contact), most customers prefer to use more modern technology and communication channels to access information. For example, modern voice communication channels, including wired and mobile phone systems, can provide flexibility and real-time access to information from customer service representatives. The Internet has also created new communications channels and, as a result, placed increasing demands on businesses to communicate and provide service to customers through e-mail and the Web.

Many businesses, including companies that have large customer segments, have invested in message centers that are capable of handling high call volumes on a daily basis. Despite such investments, customers are often required to wait extended periods of time on the phone before being connected with a customer service agent or before receiving any requested information. Some call centers incorporate automated, voice response equipment to process call traffic and provide easy access to frequently requested information. While such attempts have proven useful, they do not mitigate the majority of call traffic and, in certain cases, fail to provide the necessary support or information for customers.

As companies attempt to provide more efficient and personalized customer service, there is an increasing demand to handle higher volumes of requests by e-mail, the Web and other communication channels facilitated by the Internet. The Internet and the World Wide Web provide a global communications architecture that permits users to access information from Web sites and communicate using e-mail and other electronic communication or messaging techniques. As individuals become more accustomed to the Internet and electronic communication, the ability to adapt and use these communication channels will enable companies to successfully mitigate call traffic and provide service at a lower cost. There are, however, several existing challenges that face companies seeking to provide these new communication channels for customers.

For example, modern public communication networks, such as the public Internet, do not provide sufficient privacy or protection to permit confidential information to be transmitted to customers. Customers seeking confidential information, such as balance or credit information in relation to their financial account, must be supported with a communication channel or method that is secure to maintain privacy and confidentiality. Further, Web sites and customer databases are subject to attack and infiltration by unauthorized users or hackers. Therefore, additional measures must be taken to provide secure communication over public communications networks, especially when sensitive or confidential information needs to be stored and/or provided to customers.

Companies must also deal with integrating existing database and messaging systems to accommodate these more modern communication channels. While these existing systems may permit call center activity and internal e-mail routing, they are often limited or incompatible with modern technology (such as technology that permits communication through a Web site or public e-mail routing). Thus, companies are faced with either replacing their existing systems or finding a solution that will permit integration of newer technology, while still maintaining their investment in their existing customer contact systems.

Moreover, past attempts to provide e-business solutions and customer messaging by e-mail or other electronic messaging arrangements have not proven useful. For example, many e-business applications that permit customers to submit inquiries by e-mail or through a Web site are not compatible with legacy messaging systems. Further, past attempts are limited in their handling of customer messages and/or do not provide sufficient information to permit proper handling of customer messages by a message center.

### SUMMARY OF THE INVENTION

In accordance with embodiments of the invention, systems and method are provided for facilitating secured messaging. Generally, such systems and methods provide secured messaging in a network environment that includes a public communications network, such as the Internet. Embodiments of the invention may be adapted to provide secured electronic messaging for facilitating communications between, for example, customers and a customer service or message center. Embodiments of the invention may also be adapted to provide secured messaging in network environments that incorporate legacy or existing systems.

Consistent with embodiments of the invention, a method is provided for secured messaging. The method includes: receiving, over a first secured communications channel, a message from a customer at a customer location; translating the message from the customer location into an e-mail, the e-mail being addressed to an address that is accessible by a message center through a legacy messaging system; retrieving, at the message center, the e-mail through the legacy messaging system; preparing, at the message center, a reply e-mail that includes a response to the message from the customer location; retrieving, over a second secured communications channel, the reply e-mail from the legacy messaging system; and translating the reply e-mail into a message format that can be presented to the customer at the customer location.

Consistent with yet additional embodiments of the invention, a system is provided for secured messaging between a customer and a message center. The system includes: means for receiving a message from the customer at a customer location; means for translating the message from the customer location into an e-mail, the e-mail being addressed to a mailbox address that is accessible by the message center through a legacy messaging system; means for retrieving, at the message center, the e-mail through the legacy messaging system; means for preparing, at the message center, a reply e-mail that includes a response to the message from the customer location; means for retrieving, at an applications server, the reply e-mail from the legacy messaging system; and means for translating the reply e-mail into a message format that can be presented to the customer at the customer location.

Other embodiments of the invention provide a method for provide secure messaging between a plurality of customers and a message center. Such methods include: providing a Web site that is accessible over the Internet, the Web site including at least one message input screen; receiving, as part of a secure messaging session with a customer location, a message from a customer entered through the at least one message input screen; forwarding, as part of a secure Hypertext Transfer Protocol (HTTPS) request, the message of the customer to an applications server; constructing, at the applications server, an e-mail containing the message of the customer, the e-mail being addressed to a private mailbox address that is accessible by the message center; and examining, at the message center, the e-mail constructed by the applications server and generating a reply e-mail, the reply e-mail including a reply to the message of the customer.

Systems for providing secure messaging may also be implemented, consistent with the invention. Such systems may include: a Web server connected to a plurality of customer locations over a public communications network, the Web server being adapted to receive a message from a customer during a secure messaging session with one of the plurality of customer locations; an applications server connected to the Web server and adapted to receive the message from the customer during a secure messaging session with the Web server; and a private e-mail system connected to the applications server and a message center.

In response to the message from the customer, the applications server may be adapted to: construct an e-mail containing the message of the customer, the e-mail being addressed to a private mailbox address that is accessible by the message center through the private e-mail system; retrieve, through the private e-mail system, a reply e-mail generated by the message center, the reply e-mail including a reply to the message of the customer; and translate the reply e-mail into a message format that can be presented to the customer at the customer location.

Consistent with additional embodiments of the invention, systems may be provided for secure messaging. These systems may include: a Web server adapted to receive a message from a customer during a secure messaging session with a customer location; an applications server connected to the Web server and adapted to receive the message from the customer during a secure messaging session with the Web server; and a messaging system connected to the applications server and a message center.

In response to the message from the customer, the applications server may be adapted to: construct an e-mail containing the message of the customer, the e-mail including a data header with customer information and message handling information; forward the e-mail to an address that is accessible by the message center through the messaging system; retrieve, through the messaging system, a reply e-mail generated by the message center, the reply e-mail including a reply to the message of the customer; and translate the reply e-mail into a message format that can be presented to the customer at the customer location.

It is to be understood that both the foregoing general description and the following detailed description are exemplary and explanatory only, and should not be deemed restrictive of the full scope of the invention, as claimed herein.

### BRIEF DESCRIPTION OF THE DRAWINGS

The accompanying drawings, which are incorporated herein and constitute a part of this specification, illustrate various features and aspects of embodiments of the invention. In the drawings:

FIG. 1 illustrates an exemplary system environment for providing secured messaging, consistent with embodiments of the invention;

FIG. 2 is an exemplary flowchart of a method for providing secured messaging, consistent with embodiments of the invention;

FIG. 3 illustrates another exemplary system environment for providing secured messaging, consistent with embodiments of the invention;

FIG. 4 is another exemplary flowchart for providing secured messaging, consistent with embodiments of the invention;

FIG. 5 is an exemplary data header that may be included in an e-mail message constructed by an applications server, consistent with embodiments of the invention;

FIG. 6 is an exemplary reply e-mail returned by a message center, consistent with embodiments of the invention; and

FIG. 7 is an exemplary reply message presented to a customer, consistent with embodiments of the invention.

### DETAILED DESCRIPTION

Embodiments of the present invention provide secured messaging in a communications network environment. The network environment may include public communication channels or networks, such as the Internet. Embodiments of the invention may be implemented to facilitate secured electronic messaging between any combination of entities, such as one or more customer locations and a message center. Consistent with embodiments of the invention, arrangements may be provided to permit the servicing of customers within a network environment that integrates legacy systems associated with a message center.

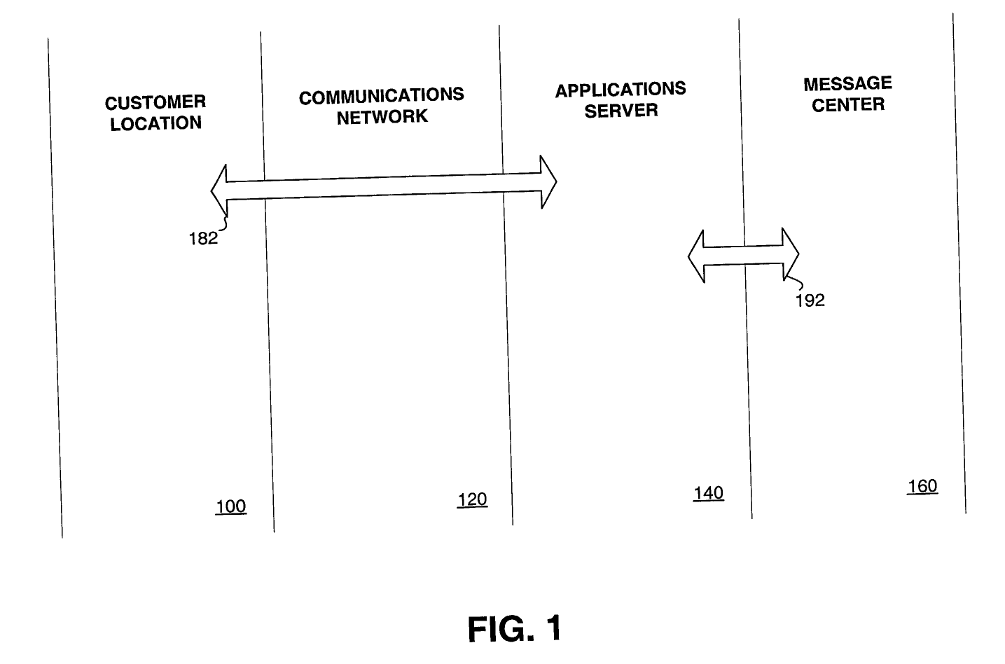

FIG. 1 illustrates an exemplary system environment for providing secured messaging, consistent with embodiments of the invention. As illustrated in FIG. 1, a number of components may be provided, including a customer location 100, a communications network 120, an applications server 140 and a message center 160. Although only one customer location 100 is illustrated in FIG. 1, any number of customer locations may be provided, with each customer location having access to or connectivity with communications network 120. Further, while only one communications network 120, one applications server 140, and one message center 160 is illustrated in FIG. 1, these components can be provided in any number or quantity, depending on the needs and requirements of the system environment.

Each customer location 100 represents the location of a customer who communicates with message center 160 through communications network 120 and applications server 140. As used herein, the term “customer” encompasses not only potential or actually customers of a company, but also partners, suppliers, clients, employees and other related entities of the company. Message center 160 may be staffed with customer service representatives or agents for the purposes of responding to messages from customers, providing information on products or services, and/or providing information concerning a customer's account (if applicable). Message center 160 may be provided for or operated by a company or business entity that provides goods or services to customers. For example, the company or business entity may be a financial institution that offers financial products or services to customers, such as savings accounts, checking accounts, credit card accounts, loans, investment services, accounting services and/or other types of financial products or services.

In FIG. 1, customer location 100 may include electronic communication equipment to access or connect to communications network 120. By way of non-limiting examples, customer location 100 may include a personal computer, a workstation or a laptop computer that is configured with a modem or other communication hardware for establishing a dial-up or permanent connection with communications network 120. Customer location 100 may also include a mobile or wireless phone, a personal digital assistant (PDA) or any other type of handheld device that is capable of establishing a wireless and/or wired connection with communications network 120. Further, the communication equipment at each customer location 100 may include communication software and other applications (such as a browser application and/or e-mail software) to facilitate communications, messaging and/or accessing of information over communications network 120.

Consistent with embodiments of the invention, communications network 120 may comprise any combination of technology and/or components for providing electronic communication with each customer location 100. For electronic or on-line communication, communications network 120 may comprise any combination of wired or wireless technologies and/or communication networks, such as an intranet, the public Internet and/or a public switched telephone network (PSTN). Local-loop systems, gateway and/or service providers (such as Internet Service Providers (ISP)) may also be provided as part of communications network 120 to facilitate connectivity and/or communication services for each customer location 100.

Applications server 140 is provided to receive, translate and/or coordinate messages between customer location 100 and message center 160. Applications server 140 may be implemented with a server or computer-based platform and may include communication hardware and software. Software may also be provided with applications server 140 to provide one or more levels of security between communications network 120 and message center 160, such as a company or private firewall. Alternatively, applications server 140 may be provided as part of a corporate or private network, that is isolated or secured from communications network 120 through a firewall. Additionally, applications server 140 may be provided with a database for storing customer information and message content information.

As indicated above, message center 160 may be staffed with customer service representatives or agents for the purposes of providing customer service features, such as responding to messages from customers, providing information, and performing other customer service functions. Message center 160 may include a number of components, such as user terminals that are operated by customer service agents. The user terminals may include computer-based workstations for accessing information requested by customers. Legacy messaging systems, which permit the sending and receiving of e-mail or other electronic messages, may also be provided as part of message center 160. Legacy systems, such as a corporate or private e-mail system, may be accessible by applications server 140 and user terminals of message center 160 a over secure communications network or secure communication links to permit the sending and receiving of e-mail or other electronic messages. By way of a non-limiting example, legacy messaging systems may be provided as part of a corporate or private network along with message center 160 and/or applications server 140. Consistent with embodiments of the invention, legacy messaging systems may also be hosted or implemented at separate location(s) from message center 160, with connectivity between these systems being provided through a secure communication network or channel, such as a local area network or a virtual private network.

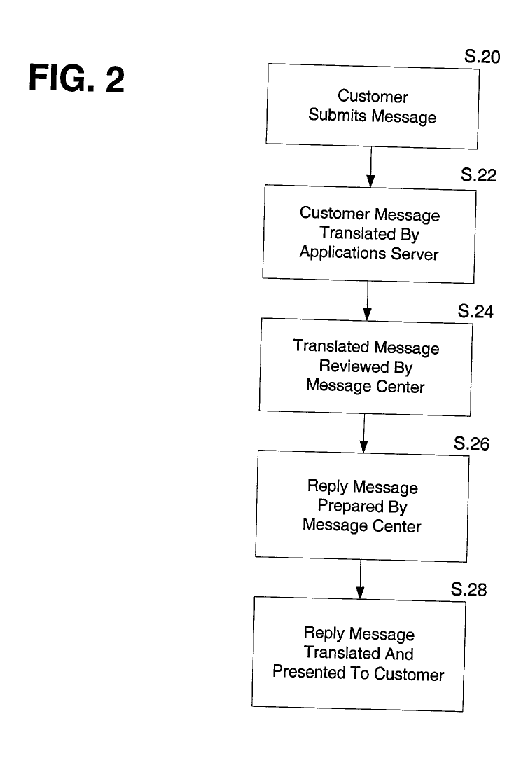

FIG. 2 is an exemplary flowchart for providing secured messaging, consistent with embodiments of the invention. The features of FIG. 2 may be used to facilitate secured messaging between any combination of entities, such as one or more customer locations and a message center. As illustrated in FIG. 2, the process begins with a customer submitting a message (step S.20). For example, a customer at customer location 100 may electronically submit a message using communications network 120. The message may be directed to message center 160 and include any combination or number of questions and/or requests for information. The message from customer location 100 may be electronically sent over communications network 120 and received by applications server 140 using a secure communications channel 182 (see FIG. 1). This secure communications channel may be provided in a number of different ways.

For example, if communications network 120 is implemented using the Internet, a Web site may be established to accept messages from customer location 100 and submit them to applications server 140. For this purpose, a Web server may be provided separately or as part of communications network 120, or could be implemented as part of applications server 140. Such a Web server may host the Web site, which may be a company Web site or a Web site operated by a third party on-behalf of the company. The content of the Web site may be stored entirely or in part on the Web server and/or applications server 140.

To provide security and restrict access, the Web site may require each customer to log-in or go through an authentication process before submitting a message. For example, a customer at customer location 100 may be required to provide authenticating information such as a valid password, account number and/or username or ID. Alternatively, the log-in or authentication process could be automated by, for example, using software that causes customer location 100 to automatically provide the necessary log-in or authentication information to the Web server. After successfully logging in, a message input screen may be displayed by the customer's browser. Using the message input screen, a customer may then submit a message or question from customer location 100 to the Web server.

Consistent with embodiments of the invention, one or more different message input screens may be presented to the customer depending on the type of question or information requested by the customer. For example, one message input screen may be provided to facilitate customers in requesting information concerning their account with a company, while other message input screens may be provided to facilitate customers in requesting general information concerning products or services of a company. A menu screen may also be provided to a customer to facilitate the selection and display of the proper message input screen(s). By using different message input screens, customer messages may be submitted and responded to more efficiently and with less errors or confusion.

Communication between the customer's browser and the Web server may follow a request/response paradigm involving Hypertext Transfer Protocol (HTTP). When an HTTP request is made by the browser (such as to view a Web page), the Web server provides a response (such as providing an HTML file to permit the Web page to be displayed by the browser). Thus, when a message input screen is completed by a customer, the content of the entered message may be sent as part of an HTTP request from the customer's browser. To transmit data between customer location 100 and the Web server, a secure messaging session may be established between the customer's browser and the Web server in accordance with a secure sockets layer protocol, such as HTTPS. Encrypted messages received from customer location 100 may be forwarded by the Web server to applications server 140. If necessary, communication between the Web server and applications server 140 may also be established using HTTPS or another protocol providing sufficient security.

Other arrangements may be provided for establishing secure communications channel 182 between customer location 100 and applications server 140. For example, a direct connection may be made between customer location 100 and applications server 140 over a PSTN or other public communications network. In such a case, customer location 100 can include applications software for dialing-up and connecting with applications server 140, as well as performing authentication and message encryption routines. The application software may also generate one or more message input screens to facilitate the entry of messages or questions by a customer. Alternatively, customer messages may be submitted to applications server 140 using an e-mail system. For instance, customer location 100 may submit messages addressed to a mailbox accessible by applications server 140. For this purpose, an e-mail server may be provided as part of communications network 120. In addition, if a conventional, public e-mail system is used, then customer messages may be sent as an encrypted file attached to an e-mail. In such cases, various encryption techniques may be used, such as encryption algorithms based on public-private key arrangements.

Referring again to FIG. 2, after a message is submitted by customer location 100 (step S.20), the message is received and translated by applications server 140 (step S.22). Applications server 140 may perform one or more translation routines. For example, if the customer message is received in an encrypted form, applications server 140 may decrypt the message. Thereafter, applications server 140 may translate the message so that it may be accessed by message center 160. For this purpose, applications server 140 may translate the message into a format that is accessible through an existing or legacy messaging center used by message center 160. For example, if the legacy messaging system is a corporate or private e-mail system, then applications server 140 may generate an e-mail based on the customer's original message, with the e-mail being addressed to a mailbox address accessible by message center 160 through the private e-mail system.

The e-mail message generated by applications server 140 may incorporate the original message content submitted by the customer. Further, to facilitate proper handling of the customer's message, applications server 140 may incorporate other information into the e-mail message using, for example, data headers or character strings. The data headers or character strings may have a predefined format and can be included in any part of the e-mail message, such as the subject line or message field of the e-mail. The information incorporated by applications server 140 may include, for example, relevant customer information (such as a customer name or ID, and/or a customer account number). The customer information may be gathered based on information entered by the customer during an authentication process and/or may be collected from a customer database. Messaging handling information may also be includes using, for example, a message code or trigger in the subject line or message body of the e-mail. Such a message code or trigger may identify the type of message submitted by a customer (based on, for example, the type of message input screen used) and/or the priority level of the message (based on, for example, the status of the customer, the date of the original message, the type of message submitted by the customer, etc.). Consistent with embodiments of the invention, customer information and message handling information may also be provided in a file (such as a text file) that is sent as an attachment with the e-mail generated by applications server 140.

Each of translated message is then reviewed by message center 160 (step S.24). To retrieve and review a customer message, a secure communications channel 192 (see FIG. 1) is established between applications server 140 and message center 160. Secure communications channel 192 may be implemented in a number of different ways. For example, the translated customer message may be sent by applications server 140 to a legacy messaging system using a secure, private or local area network or a virtual private network. The legacy messaging system, such as a corporate or private e-mail system, may be provided as part of message center 160 or provided at a separate location. A corporate or private e-mail system may be an internal e-mail system that is generally not accessible to the public or through public communications networks. Customer service representatives of message center 160 may access the legacy messaging system to retrieve and review the customer message using a dedicated, internal communication link or a secure, local area network. Alternatively, applications server 140 may forward the translated customer messages directly to the existing messaging system or customer agent workstations of message center 160 using a secure, dial-up or permanent communication link.

Customer service representatives may poll or review customer messages on a periodic basis. If customer information is provided with a customer message, then the customer information may be used by the customer service representatives to access information (such as customer account information) and/or determine an appropriate reply to the customer message. Further, if a message code or trigger is provided with a customer message, then the message code or trigger may be interpreted by the customer service agent to determine how to respond to the message. In addition, based on the specific nature of the customer's inquiry or the reply from the message center, a customer service representative may determine to update or change the message code or trigger. In any event, each of the translated customer messages from applications server 140 may be reviewed and replied to by message center 160. As part of this process, a reply message is prepared by message center 160 (step S.26).

Consistent with embodiments of the invention, reply messages may be prepared by message center 160 using one or more legacy messaging systems. For example, customer service representatives may prepare a reply message to a customer using an existing corporate or private e-mail system. The reply message may include, for example, information requested by a customer and/or an answer to a question submitted by a customer. Information or answers provided in the reply message may contain confidential and/or non-confidential information. In addition, the customer's original message may be included as part of the reply message, as well as the relevant customer information (such as a customer name or ID, and/or a customer account number).

Reply messages generated by message center 160 may be forwarded to or retrieved by applications server 140. For example, using secure communications channel 192 (see FIG. 1), reply messages may be forwarded to or retrieved by applications server 140. In such cases, a customer service representative may send a reply message using the existing messaging system associated with message center 160. The reply message may be addressed to a mailbox address accessible by applications server 140. Applications server 140 may retrieve reply messages from the legacy messaging system through, for example, a secure, dial-up or permanent communication link, a private network or a virtual private network. Alternatively, the legacy messaging system may forward the reply message directly to applications server 140 using a secure, dial-up or permanent communication link or virtual private network.

Reply messages from message center 160 are translated by applications server 140 into a message format that can be presented to individual customers (step S.28). Reply messages may be translated in a number of different ways. For example, if customers are permitted to view reply message through a Web site, then applications server 160 may construct an HTML file to present the content of the reply message as part of a display screen generated by the customer's browser. Each HTML file may be indexed and stored in a database of applications server 140 according to customer identification information (customer name or ID, and/or customer account number). As part of step S.28, applications server 140 may generate an e-mail or post a message at a Web site to notify the customer that a reply from message center 160 is available. The customer at customer location 100 may then log on the Web site (if the customer is not already authenticated on the Web site) and request to view the reply message. In response to the request, applications server 140 may retrieve and forward the HTML file containing the content of the reply message to the Web server, which in turn would forward the HTML file to customer location 100. Using the HTML file, the customer's browser would display the reply message content to the customer. To provide security, a secure messaging session may be established between customer location 100 and the Web server using a protocol such as HTTPS. As indicated above, HTTPS or another suitable protocol may also be used to transfer files between the Web server and applications server 140.

If message triggers or codes are provided in the reply e-mail, then applications server 140 may review and remove the message handling information from the reply provided to the customer. The message handling information may examined by applications server 140 to determine the final values for the trigger or codes (for example, if updates were made by the message center) and, thus, the proper handling for the reply. For example, message trigger or code values may indicate the method by which the customer is to be notified and/or presented with the reply from the message center.

In addition to using the Web, other arrangements for providing the reply message to the customer may be used depending on the type of secure communications channel 182 established between customer location 100 and applications server 140. For example, if a direct connection is made between customer location 100 and applications server 140 over a PSTN or another type of public communications network, then the reply message may be encrypted by applications server 140 and sent in a file format (such a text file) that may be opened and viewed by customer location 100. Alternatively, reply messages may be forwarded by applications server 140 using an e-mail system. For instance, applications server 140 may send the reply message to a mailbox accessible by customer location 100. If a conventional, public e-mail system is used, then the reply message may be sent by applications server 140 as an encrypted file attached to an e-mail addressed to the customer.

As indicated above, embodiments of the invention provide secured messaging in a communications network environment, such as the Internet. Systems and methods consistent with the embodiments of the invention may be implemented to facilitate messaging of both confidential and non-confidential information. Such systems and methods may also be adapted to permit a message center to provide customer service in an environment that integrates legacy messaging systems of a message center.

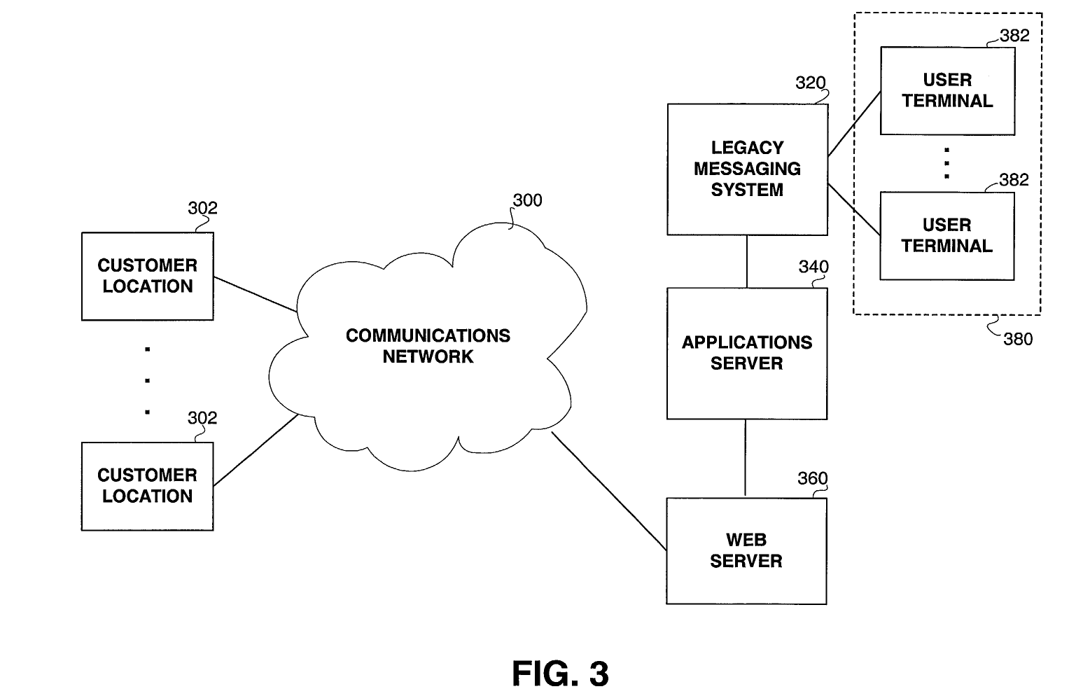

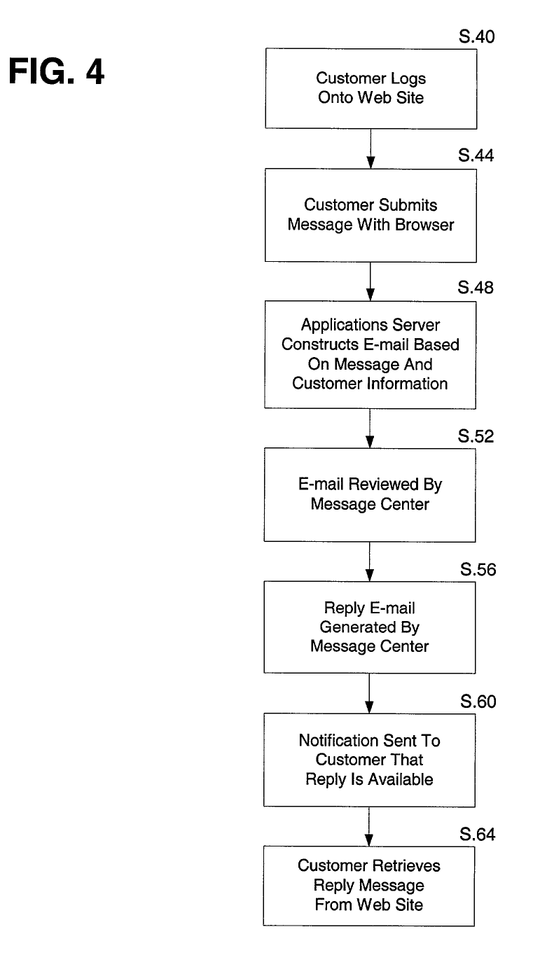

Referring now to FIG. 3, another exemplary system environment is illustrated, consistent with embodiments of the invention. The exemplary system environment of FIG. 3 may be adapted for use by a company that provides customer service features to its customers. For purposes of illustration, the exemplary system environment of FIG. 3 and the related, exemplary method of FIG. 4 will be described with reference to a financial company that provides financial products or services to customers, such as credit card accounts. It will be appreciated, however, that the examples of FIGS. 3 and 4 may be adapted for use by customers of other products or services, as well as different types of companies that offer customer service features.

As illustrated in FIG. 3, a number of components may be provided in the exemplary system environment. For example, the system environment may include one or more customer locations 302, a communications network 300, a Web server 360, an applications server 340, a legacy messaging system 320 and a message center 380. Although two customer locations 302 are illustrated in FIG. 3, any number of customer locations may be provided, with each customer location having access to or connectivity with communications network 300. Further, while one communications network 300, one Web server 360, one applications server 340, one legacy messaging system 320 and one message center 380 is illustrated in FIG. 3, these components may be provided in any number or quantity, depending on the needs and requirements of the system environment.

Similar to customer locations 100 of FIG.1, each customer location 302 of FIG. 3 represents the location of a customer who communicates with message center 380 through communications network 300. In the exemplary system environment of FIG. 3, the term “customer” encompasses not only potential or actually customers of a company, but also partners, suppliers, clients, employees and other related entities of the company. Message center 380 includes one or more user terminals 382 that are staffed with customer service representatives or agents for the purposes of responding to messages from customers, providing information on products or services, and/or providing information concerning a customer's account (if applicable). By way of a non-limiting example, message center 380 may be provided for or operated by a financial company or business entity that provides financial products or services to customers. For example, the financial company or business may provide one or more different types of credit card accounts to customers.

To access or connect to communications network 300, customer location 302 may include suitable communication equipment. By way of non-limiting examples, customer location 302 may include a personal computer, a workstation or a laptop computer that is configured with a modem or other communication hardware for establishing a dial-up or permanent connection with communications network 300. Customer location 302 may also include a mobile or wireless phone, a personal digital assistant (PDA) or any other type of handheld device that is capable of establishing a wireless and/or wired connection with communications network 300. Further, the communication equipment at each customer location 302 may include communication software and other applications (such as a browser application and/or e-mail software) to facilitate communications, messaging and/or accessing of information over communications network 300.

Communications network 300 facilitates communication between client locations 302 and the other system components of FIG. 3. For this purpose, communications network 300 may include any combination of technology and/or components for providing electronic communication. For example, communications network 300 may comprise any combination of wired or wireless technologies and/or communication networks, such as an intranet, the public Internet and/or a public switched telephone network (PSTN). Local-loop systems, gateway and/or service providers (such as Internet Service Providers (ISPs)) may also be provided as part of communications network 300 to facilitate connectivity and/or communication services for each customer location 302.

Web server 360 hosts one or more Web sites that are accessible to customer locations 302. Each Web site may be a company Web site, or a Web site that is operated by a third party on behalf of the company. The Web site may include a secure messaging portal or center for customers of the company to submit and receive messages. The content of each Web site may be stored entirely or in part on the Web server 360 and/or applications server 340. As further described below, a Web site may be provided to facilitate the submission of messages by customer locations 302 and the retrieval of reply messages from message center 380. Although FIG. 3 illustrates Web server 360 as being connected to communications network 300, Web server 360 may actually form part of the infrastructure for communications network 300.

Applications server 340 facilitates integration of legacy messaging system 320. Applications server 340 may be implemented with a server or computer-based platform and may include communication hardware and software. Software may also be provided with applications server 340 to perform message handling and routing functions, such as those described below in connection with FIG. 4. In addition, applications server 340 may include software to provide one or more levels of security between communications network 300 and message center 380, such as a company or private firewall. Alternatively, applications server 340 may be provided as part of a corporate or private network, that is isolated or secured from communications network 300 through a firewall. Additionally, applications server 340 may also be provided with a database for storing customer information (such as customer name, account number(s), e-mail address, etc.) and message information.

The exemplary system environment of FIG. 3 may include one or more legacy messaging systems 320. By way of a non-limiting example, legacy messaging system 320 may be a corporate or private e-mail system or other type of electronic messaging system. The corporate or private e-mail system may be an internal e-mail system that is part of a corporate or private network and generally not accessible to the public or through public communications networks. Alternatively, the corporate or private e-mail system may be hosted externally, with access to the system being provided through a secured communication link or network, such as a virtual private network. The corporate or private e-mail system may incorporate functions to facilitate message tracking, categorization and handling by message center 380. Examples of commercially available e-mail or messaging systems include Kana Response, available from Kana Communications, Inc. of Redwood City, Calif.

As illustrated in FIG. 3, message center 380 may include one or more user terminals 382. User terminals 382 may be staffed with customer service representatives or agents for providing customer service features, such as responding to messages from customers, providing information, and performing other customer service functions. Each of the user terminals 382 may include computer-based workstations or terminals for sending and/or receiving messages through legacy messaging system 320. User terminals 382 may also be connected to a corporate database server for accessing and retrieving information requested by customers. Connectivity between user terminals 382 and legacy messaging system 320 and the corporate database server may be provided through a secure, direct communication link or private communication network, such as a local area network.

FIG. 4 illustrates an exemplary flowchart for providing secured messaging, consistent with embodiments of the invention. The features of FIG. 4 may be used to facilitate secured messaging between entities in the exemplary system environment of FIG. 3, such as customer locations 302 and message center 380. The exemplary process of FIG. 4 begins with a customer logging onto a Web site (step S.40). As indicated above, the Web site may be established by a company to accept and handle messages from customer locations 302. The Web site may be hosted by Web server 360, with the content of the Web site being stored entirely or in part on Web server 360 and/or applications server 340.

Using a browser, each customer location 302 may connect to the Web site through communications network 300. Once connected to the Web site, a customer may be required to log-in or go through an authentication process before being able to submit messages to message center 380. For example, customer location 302 may be required to provide authenticating information such as a valid password, account number and/or username or ID. Alternatively, the log-in or authentication process could be automated by, for example, using software that causes customer location 100 to automatically provide the necessary log-in or authentication information to the Web server.

After logging on to the Web site, the authenticated customer may then submit a message using the browser at customer location 302 (step S.44). The message include any combination or number of questions and/or requests for information. To facilitate the entry of messages, a message input screen may be generated by the customer's browser. For this purpose, an HTML file for generating a message input screen may be provided by Web server 360 to customer location 302. A generic message input screen may be provided for all messages submitted by a customer. The generic input screen may include a subject select field to permit the customer to indicate the nature of his/her inquiry, and a comment field to enter the content of the message. Alternatively, depending on the type of question or information requested by the customer, specific message input screens may be generated by the customer's browser. For example, one message input screen may be provided to facilitate the customer in requesting information concerning their credit card account, while other message input screens may be provided to facilitate the customer in requesting general information concerning financial products or services of the company. If different message input screens are available, a menu screen may be displayed to the customer to facilitate the ultimate selection and display of the proper message input screen(s) by the customer's browser.

Once the message input screen is completed, the customer may submit the message (for example, by selecting a SEND or SUBMIT button). As part of this process, the information entered through the message input screen may be sent as part of an HTTP request from the customer's browser to Web server 360. To transmit the message information between customer location 302 and Web server 360 in a secured fashion, a secure messaging session may be established between the customer's browser and Web server 360 in accordance with a secure sockets layer protocol, such as HTTPS. Web server 360 may forward the HTTP request to applications server 340 for further processing. If necessary, communication between Web server 360 and applications server 340 may also be established using HTTPS or another protocol providing sufficient security.

Referring again to FIG. 4, after the message information is submitted by customer location 302 (step S.44), applications server 340 may generate an e-mail for message center 380 based on the message information and relevant customer information (step S.48). For example, the subject field for the e-mail may be populated with the message type or subject selected by the customer. Further, the “to” address for the e-mail may be a mailbox address of message center 380 that is accessible through legacy messaging system 320. The “from” address for the e-mail may be the customer's username or Web ID (such as an on-line Web servicing ID) with a domain associated with applications server 340. The body of the e-mail may contain the message content or text information entered by the customer. The body of the e-mail may also include data or message headers to facilitate handling of the e-mail.

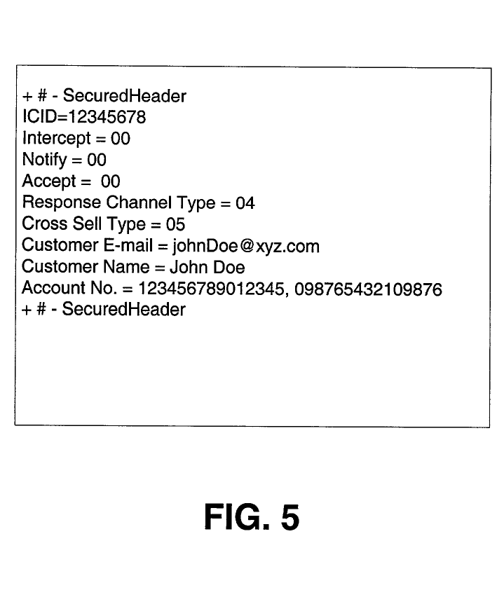

FIG. 5 illustrates an exemplary data header that may be included in the e-mail messages constructed by applications server 340. As illustrated in FIG. 5, the data header includes a character string (“+#−SecuredHeader”) that initializes and closes the data header. The data header may include information that are used by customer service representatives at message center 380 in order to determine how to handle and/or respond to the customer's message. This information may include customer information (such as an Internet customer ID (ICID), a customer's name, customer account number(s), a customer's personal e-mail address, etc.), as well as marketing or response information (such as Response Channel Type, Cross Sell Type, etc.). Relevant customer information may be gathered based on the information provided by a customer during an authentication process and/or accessed from a customer database. Marketing or response information may be incorporated into the e-mail by application server 340 based on numerous factors, such as the type of inquiry or message submitted by the customer, the status of the customer, the type of products or services requested by the customer, etc.

As further described below, the data header may also include message triggers (such as Intercept, Notify, Accept) which are set to initial values by applications server 340 to indicate handling instructions for the customer's message. These message triggers may be changed or updated to different values when the message is reviewed at message center 380. For example, a customer service representative may determine that an initial value of a message trigger is improper based on the type of message or reply to be provided to the customer and may update the message trigger value to provide proper notification and/or handling of the reply for the customer.

After constructing the e-mail message, applications server 340 will forward the e-mail to legacy messaging system 320. A secure, direct communication link or private network (such as a local area network) may be used to forward the e-mail from applications server 340 to legacy messaging system 320. The e-mail may be sent to a general mailbox address for message center 380. Alternatively, alias addresses may be defined for different categories of messages. Alias addresses may be formed from a combination of a codeword representing the message input screen type or subject selected by the customer and a domain associated with message center 320. Consistent with embodiments of the invention, a set of alias addresses may be defined for customer's messages related to confidential information (such as questions related to a customer's credit card account) as well as customer's messages related to non-confidential information (such as an inquiry for application information for a financial product or service of the company, or a request concerning job openings with the company). The use of alias addresses may permit e-mails received by legacy messaging system 320 to be routed to the appropriate group or set of customer service representatives at message center 380.

Referring again to FIG. 4, e-mails constructed by applications server 340 are reviewed by message center 380 (step S.52). To retrieve and review a customer message, a secure communications channel is established between applications server 340 and message center 380. For example, communication between each of the user terminals 382 and legacy messaging system 320 may be established using a secure, direct communication link or a private network, such as local area network. With such a secure communications channel, customer service representatives at message center 380 may access legacy messaging system 320 through user terminals 382 to retrieve and review e-mails containing a customer's original message.

When reviewing an e-mail, a customer service representative may examine the content of the customer's original message to determine the nature of the inquiry. The customer service representative may also inspect the data header created by applications server 340 to identify the customer, access customer account information and/or determine how the message should be handled. As indicated above, message triggers can also be included in the data header with values initialized by applications server 340. Such message triggers may be used to categorize the customer's message and/or provide message handling instructions. By way of non-limiting examples, message triggers and associated trigger values may be defined as follows:

INTERCEPT—Determines whether or not the customer will be notified of a reply message at the time of authentication into the Web site. If this value is required, the customer is required to read the reply message in order to proceed to other pages in the Web site. Exemplary INTERCEPT values: 0=none; 1=suggested intercept; and 2=required intercept.

NOTIFY—Indicates whether or not a notification message will be sent to the customer's personal e-mail address to indicate that a reply message is available. Exemplary NOTIFY values: 0=no notification; 1=send notification e-mail to customer.

ACCEPT—Specifies whether or not an Acceptance of Terms prompt will be presented to the customer following the review of the message. Exemplary ACCEPT values: 0=no acceptance of prompt required; 1=acceptance of terms prompt required.

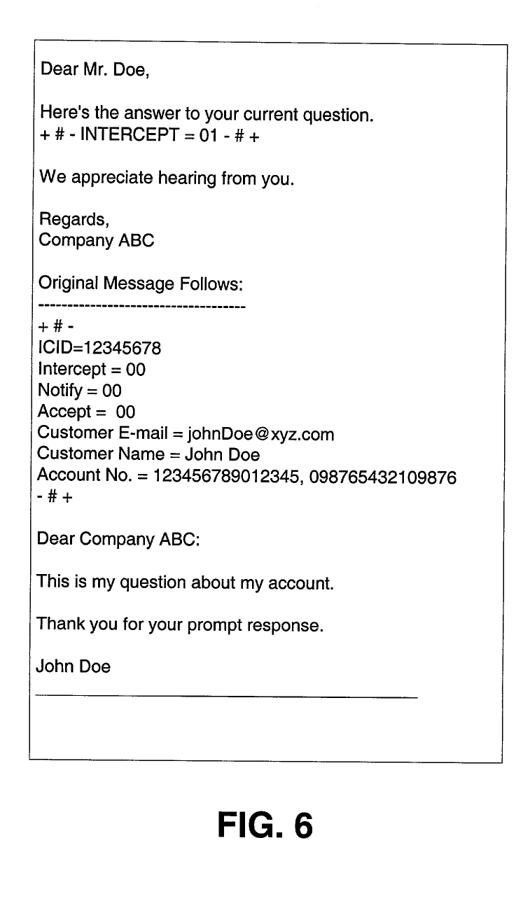

After each e-mail is reviewed at message center 380, a customer service representative will formulate a response and generate a reply e-mail (step S.56). The reply e-mail is forwarded by message center 380 to legacy messaging system 320 using a mailbox address that is accessible by applications server 340. FIG. 6 illustrates an exemplary reply e-mail, consistent with embodiments of the invention. As illustrated in FIG. 6, the reply e-mail may include the original message from the customer, as well as a message header that contains the reply message from a customer service representative. The data header created by applications server 340 is also maintained in the reply e-mail. However, the initial values of the message triggers may change based on new data headers added to the reply. This may occur if the customer service representative decides to change or update the value or uses a message template which includes a message header with a predefined trigger value. In the exemplary reply e-mail of FIG. 6, a message header is used with a INTERCEPT trigger. This trigger will set the value for INTERCEPT to “01” when the reply e-mail is processed by applications server 340.

Each reply e-mail sent to legacy messaging system 320 is retrieved and processed by applications server 340. To determine the proper handling for the reply, applications server 340 may parse the message trigger values in the data headers by scanning the reply e-mail from top to bottom. The first instance of each trigger may be used by applications server 340 to set the trigger value. After parsing, applications server 340 will strip or remove all data headers from the text body of the reply e-mail, and prepare an HTML file so that the reply message can be presented to the customer through the Web. Alternatively, if the original message and reply relate to non-confidential information, an e-mail may be constructed from the reply message and sent to a personal e-mail address of the customer.

After the reply e-mail is processed by applications server 340, notification is sent to the customer that a reply is available (step S.60). As indicated above, message triggers may be provided to indicate how notification is sent to the customer by applications server 340. Thus, for example, the set trigger values may indicate that notification be sent to the customer's personal e-mail address. Alternatively, the set trigger values may indicate that notification be presented to the customer the next time the customer logs in and is authenticated through the Web site.

After receiving notification, the customer at customer location 302 may log on the Web site (if the customer is not already logged and authenticated on the Web site) and retrieve the reply message (step S.64). As part of this process, applications server 340 may retrieve and forward the HTML file containing the content of the reply message to Web server 360. In turn, Web server 360 forwards the HTML file to customer location 302 and, using the HTML file, the customer's browser can display the reply message.

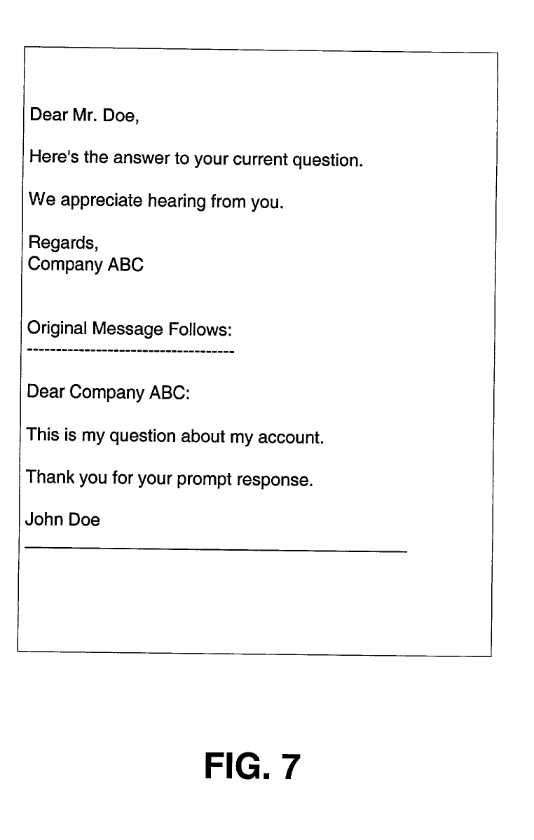

By way of a non-limiting example, FIG. 7 illustrates an exemplary reply message that may be displayed with a customer's browser. As shown in the FIG. 7, the reply message text from the customer service representative and the customer's original message may be displayed to the customer. All data headers are removed and do not appear in the reply message.

To provide security, a secure messaging session may be established between customer location 302 and Web server 360 when an HTML file containing the reply message is forwarded to the customer location. For this purpose, a protocol such as HTTPS may be used to establish a secure messaging session. HTTPS or another suitable protocol may also be used to transfer HTML files between Web server 360 and applications server 340.

Other embodiments of the invention will be apparent to those skilled in the art from consideration of the specification and practice of the invention disclosed herein. For example, the pre-existing or legacy messaging system may incorporate templates that can be used by customer service representatives to construct a reply message to customers. Alternatively, reply messages from service representatives may be composed using free form text entered using the legacy messaging system.

In addition, the invention is not limited to the particulars of the embodiments disclosed herein. For example, the individual features of each of the disclosed embodiments may be combined or added to the features of other embodiments. In addition, the steps of the disclosed methods herein may be combined or modified without departing from the spirit of the invention claimed herein. For instance, messages may be received from both authenticated and non-authenticated customers. If a message is sent from an authenticated customer, it can be considered confidential with a reply message handled according to the secured messaging techniques disclosed herein. In contrast, non-confidential messages or messages received from non-authenticated customers may handled as general inquiries (such as from the public at large). In such cases, reply messages may be sent to a personal e-mail address of the entity that submitted the original message.

Accordingly, it is intended that the specification and embodiments disclosed herein be considered as exemplary only, with a true scope and spirit of the invention being indicated by the following claims.

What is claimed is:

1. A method for providing secured messaging, the method comprising:
receiving, over a first secured communications channel, a message from a customer at a customer location;
translating the message from the customer location into an e-mail, the e-mail being addressed to an address that is accessible by a message center through a legacy messaging system;
retrieving, at the message center, the e-mail through the legacy messaging system;
preparing, at the message center, a reply e-mail that includes a response to the message from the customer location;
retrieving, over a second secured communications channel, the reply e-mail from the legacy messaging system; and
translating the reply e-mail into a message format that can be presented to the customer at the customer location.

2. A method according to claim 1, wherein the step of receiving the message from the customer comprises:
establishing a secure messaging session between the customer location and a Web server;
generating a message input screen at the customer location to permit entry of the message of the customer; and
transmitting a secure Hypertext Transfer Protocol (HTTPS) request from the customer location to the Web server, the HTTPS request including the message of the customer entered through the message input screen.

3. A method according to claim 2, wherein the step of receiving further comprises forwarding the HTTPS request from the Web server to an applications server.

4. A method according to claim 3, wherein the step of forwarding comprises establishing a secure messaging session between the Web server and the applications server using a secure sockets layer protocol.

5. A method according to claim 3, wherein the step of translating the message from the customer location comprises:
constructing, at the applications server, an e-mail addressed to the message center, the e-mail including customer information and at least one message trigger with an initial value; and
forwarding the e-mail addressed to the message center from the applications server to the legacy messaging system.

6. A method according to claim 5, further comprising:
examining, at the message center, each message trigger provided in the e-mail to determine if the initial value assigned to the message trigger is proper; and
updating, in the reply e-mail, the value of each message trigger if the initial value is determined to be improper.

7. A method according to claim 6, further comprising:
inspecting, at the applications server, the value of each message trigger; and
notifying, based on the value of each message trigger, the customer at the customer location that a reply from the message center is available.

8. A method according to claim 1, wherein the customer location includes a Web browser and further wherein the step of translating the reply e-mail comprises constructing an HTML file that can be interpreted by the Web browser at the customer location to display the response to the customer.

9. A method according to claim 1, further comprising:
notifying the customer at the customer location that a reply from the message center is available; and
forwarding, upon request from the customer, the reply e-mail in the message format that can be presented to the customer at the customer location.

10. A method according to claim 1, wherein the step of retrieving the reply e-mail comprises:
providing the second secured communications channel between the legacy messaing system and an applications server; and
forwarding the reply e-mail over the second secured communications channel from the legacy messaging system to the applications server.

11. A method according to claim 10, wherein the step of translating the reply e-mail comprises constructing an HTML file that can be interpreted by a Web browser at the customer location to display the response to the customer.

12. A system for providing secured messaging between a customer and a message center, the system comprising:
means for receiving a message from the customer at a customer location;
means for translating the message from the customer location into an e-mail, the e-mail being addressed to a mailbox address that is accessible by the message center through a legacy messaging system;
means for retrieving, at the message center, the e-mail through the legacy messaging system;
means for preparing, at the message center, a reply e-mail that includes a response to the message from the customer location;
means for retrieving, at an applications server, the reply e-mail from the legacy messaging system; and
means for translating the reply e-mail into a message format that can be presented to the customer at the customer location.

13. A system according to claim 12, wherein the means for receiving the message from the customer comprises:
means for establishing a secure messaging session between the customer location and a Web server;
means for generating a message input screen at the customer location to permit entry of the message of the customer; and
means for transmitting a secure Hypertext Transfer Protocol (HTTPS) request from the customer location to the Web server, the HTTPS request including the message of the customer entered through the message input screen.

14. A system according to claim 13, wherein the means for receiving the message from the customer further comprises means for forwarding the HTTPS request from the Web server to an applications server.

15. A system according to claim 14, wherein the means for forwarding the HTTP request comprises means for establishing a secure messaging session between the Web server and the applications server using a secure sockets layer protocol.

16. A system according to claim 14, wherein the means for translating the message from the customer comprises:
means for constructing, at the applications server, the e-mail addressed to the message center, the e-mail including customer information and at least one message trigger; and
means for forwarding the e-mail addressed to the message center from the applications server to the legacy messaging system.

17. A system according to claim 12, wherein the customer location includes a Web browser and further wherein the means of translating the reply e-mail comprises means for constructing an HTML file that can be interpreted by the Web browser at the customer location to display the response to the customer.

18. A system according to claim 12, further comprising:
means for notifying the customer at the customer location that a reply from the message center is available; and
means for forwarding, upon request from the customer, the reply e-mail in the message format that can be presented to the customer at the customer location.

19. A system according to claim 12, wherein the means for retrieving the reply e-mail comprises:
means for providing a secure communications channel between the legacy messaging system and an applications server; and
means for forwarding the reply e-mail over the secure communications channel from the legacy messaging system to the applications server.

20. A system according to claim 19, wherein the means for translating the reply e-mail comprises means for constructing an HTML file that can be interpreted by a Web browser at the customer location to display the response to the customer.

21. A method for provide secure messaging between a plurality of customers and a message center, comprising:
providing a Web site that is accessible over the Internet, the Web site including at least one message input screen;
receiving, as part of a secure messaging session with a customer location, a message from a customer entered through the at least one message input screen;
forwarding, as part of a secure Hypertext Transfer Protocol (HTTPS) request, the message of the customer to an applications server;
constructing, at the applications server, an e-mail containing the message of the customer, the e-mail being addressed to a private mailbox address that is accessible by the message center; and
examining, at the message center, the e-mail constructed by the applications server and generating a reply e-mail, the reply e-mail including a reply to the message of the customer.

22. A method according to claim 21, wherein the reply e-mail is addressed to a private mailbox that is accessible by the applications server.

23. A method according to claim 22, further comprising:
forwarding, over a secure communications channel, the reply e-mail from the message center to the applications server; and
generating, at the applications server, an HTML file based on the reply e-mail from the message center, the HTML file including the reply of the message of the customer.

24. A method according to claim 21, further comprising:
providing a private e-mail system that is accessible to the applications server and the message center.

25. A method according to claim 24, further comprising:
forwarding, from the applications server to the private e-mail system, the e-mail addressed to the private mailbox address of the message center; and
retrieving, at the message center, the e-mail from the private e-mail system.

26. A method according to claim 24, further comprising:
forwarding, from the message center to the private e-mail system, the reply e-mail addressed to the private mailbox address of the applications server; and
retrieving, at the applications server, the reply e-mail from the private e-mail system.

27. A method according to claim 21, further comprising:
constructing, at the applications server, an HTML file based on the reply e-mail from the message center; and
forwarding, as part of a secure messaging session with the customer location, the HTML file to a Web browser at the customer location to display the reply from the message center to the customer.

28. A method according to claim 21, further comprising:
forwarding, upon request from the customer, the reply e-mail in a message format that can be presented to the customer at the customer location.

29. A method according to claim 21, further comprising:
in response to the reply e-mail, notifying the customer at the customer location that the reply from the message center is available.

30. A system for providing secure messaging, the system comprising:
a Web server connected to a plurality of customer locations over a public communications network, the Web server being adapted to receive a message from a customer during a secure messaging session with one of the plurality of customer locations;
an applications server connected to the Web server and adapted to receive the message from the customer during a secure messaging session with the Web server; and
a private e-mail system connected to the applications server and a message center;
wherein, in response to the customer message received from the Web server, the applications server is adapted to:
construct an e-mail containing the message of the customer, the e-mail being addressed to a private mailbox address that is accessible by the message center through the private e-mail system;
retrieve, through the private e-mail system, a reply e-mail generated by the message center, the reply e-mail including a reply to the message of the customer; and
translate the reply e-mail into a message format that can be presented to the customer at the customer location.

31. A system according to claim 30, further comprising means for notifying the customer at the customer location that the reply from the message center is available.

32. A system according to claim 31, further comprising means for forwarding, upon request from the customer, the reply e-mail in a message format that can be presented to the customer at the customer location.

33. A system according to claim 30, wherein the applications server is adapted to translate the reply e-mail from the message center into an HTML file and further wherein the HTML file is forwarded by the Web server, as part of a secure messaging session with the customer location, to a Web browser at the customer location to display the reply from the message center to the customer.

34. A system for providing secure messaging, the system comprising:
a Web server adapted to receive a message from a customer during a secure messaging session with a customer location;
an applications server connected to the Web server and adapted to receive the message from the customer during a secure messaging session with the Web server; and
a messaging system connected to the applications server and a message center;
wherein, in response to the message from the customer, the applications server is adapted to:
construct an e-mail containing the message of the customer, the e-mail including a data header with customer information and message handling information;
forward the e-mail to an address that is accessible by the message center through the messaging system;
retrieve, through the messaging system, a reply e-mail generated by the message center, the reply e-mail including a reply to the message of the customer; and
translate the reply e-mail into a message format that can be presented to the customer at the customer location.
